(19) United States
(12) Patent Application Publication
(10) Pub. No.: US 2013/0268361 A1
(43) Pub. Date: Oct. 10, 2013

(54) SYSTEMS AND METHODS FOR IMPLEMENTING A USER-DIRECTED LANDING PAGE FOR GENERATING ENHANCED USER CONTACT INFORMATION BASED ON USER INTERACTIVE COMPUTER SEARCHES

(71) Applicant: Michael William URBANSKI, Annapolis, MD (US)

(72) Inventor: Michael William URBANSKI, Annapolis, MD (US)

(21) Appl. No.: 13/902,759

(22) Filed: May 24, 2013

Related U.S. Application Data
(63) Continuation-in-part of application No. 13/893,774, filed on May 14, 2013.
Application No. 13/893,774 is a continuation of application No. 13/542,597, filed on Jul. 5, 2012, now Pat. No. 8,452,659.
Application No. 13/542,597 is a continuation of application No. 13/053,869, filed on Mar. 22, 2011, now Pat. No. 8,452,658.
(60) Provisional application No. 61/381,235, filed on Sep. 9, 2010.

(51) Int. Cl. G06Q 30/02; G06F 17/30

(52) U.S. Cl. CPC G06Q 30/0256; G06F 17/30864
USPC 705/14.54; 707/706; 705/26.61

(57) ABSTRACT

This disclosure relates to a system and method for providing users and/or goods or services providers and/or social contacts with an interactive scheme for generating enhanced business contacts and/or enhanced social contacts in an automated manner while the user gains the benefit of being provided directed information responsive to user-initiated and directory-based automated information requests and searches. The disclosed scheme provides a streamlined method by which enhanced contact information may be generated with the search engine based on basic contact information provided by the user once in a search session and then used to search related data sources and databases for the user that relates to the user basic contact information..

This application is a continuation-in-part of U.S. patent application Ser. No. 13/893,774, filed on May 14, 2013, which is a continuation of U.S. patent application Ser. No. 13/542,597, filed on Jul. 5, 2012, which is a continuation of U.S. patent application Ser. No. 13/053,869, filed on Mar. 22, 2011, which claims priority from U.S. Provisional Patent Application No. 61/381,235, filed on Sep. 9, 2010, and U.S. Provisional Patent Application No. 61/316,695, filed on Mar. 23, 2010, the disclosures of which are hereby incorporated by reference herein in their entireties.

This application is related to U.S. patent application No. [Attorney Docket No. 085-0003-CIP1], filed on May 24, 2013, entitled “Systems And Methods For Implementing An Advanced User Interactive Search Engine,” the disclosure of which is hereby incorporated by reference herein in its entirety.

### BACKGROUND

1. Field of the Disclosed Embodiments

This disclosure relates to systems and methods for providing users and/or goods providers, services providers, or social contacts, with an interactive scheme for generating enhanced business contacts and/or enhanced social contacts in an automated manner while the user gains the benefit of being provided directed information responsive to user-initiated and directory-based queries and/or information requests.

2. Related Art

A nearly limitless universe of information is available to users via the Internet. For many, the Internet has supplanted other more traditional information sources and advertising media to provide a medium by which the users are able to search for goods to purchase and services for which to contract. Users turn to the Internet as a most readily-available source by which to scan an increasingly broad marketplace for purchasing any manner of consumer goods and procuring all types of provided services. The information provided to the user in response to a user-initiated information request may include, not only the specific information for which the user is searching, but may also provide additional information that is intended to be made available to aid the user in making decisions regarding information that the user seeks. This information includes, for example, the increasing proliferation of consumer feedback in the form of customer reviews. Users are presented, therefore, with an overwhelming amount of information by which to fuel their decision matrix, for example, when contracting for the purchase of goods or the procurement of services.

Additionally, with the explosive rise in the use of social media platforms, information exchange to the benefit of participating users provides an equally boundless source of recommendations from individuals with shared interests and perspectives, once a user's interests and perspectives are made known based on basic user inputs.

Based on the modern availability of a virtually overwhelming amount of information for business and social purposes, the concept of “surfing the net” has taken on an even broader scope than originally envisioned. This phrase now refers broadly to user interaction with the Internet using a fixed or mobile workstation, or any manner of handheld communicating device, including, but not limited to, smart phones, PDAs, tablet computers, iPads®, body-worn devices (watches, glasses, etc.) and the like. Users “surf the net” to be entertained, to keep informed, to find specific information regarding particular topics, to interact socially with others particularly those with general shared interests or particularly-targeted common interests, and to perform myriad other tasks, including to shop for goods or services. An individual user's experience with the Internet may result in an intellectual timesharing by the user between several tasks, such as those listed above, that the user may undertake in a simultaneous or near-simultaneous manner. In this regard, the user seeks to gain as much information as possible in a straightforward less cumbersome manner.

The capacity of a particular user, or category of users, to navigate the nearly limitless expanse of information available via the Internet may be facilitated through user interaction with one or more common search engines. The search engines may include the generally known and broad-based commercial search engines including Google®, Bing®, Yahoo!®, and others. The search engines may separately include any one or more of the myriad expanding social networking sites that have emerged, including Facebook®. Otherwise, the search engines may be more specific, limited in their availability to a particular group of users and/or may be categorized according to their function, search engine administrator, user audience, targeted subject matter or the like.

Generally, a user chooses a commercially-available search engine based on its availability and/or familiarity or on some other metric, which today may include, for example, a look, a “feel,” a popularity among the user's peer group (professional or social, and real or perceived) or frankly, the last commercial that the user saw regarding the advertised advantages of a particular search engine. Although often somewhat transparent to individual users, Internet search techniques fall into a number of functional types.

Directory-based search engines were among the first search engines on what was then referred to as the World Wide Web. These were essentially cataloging sites that listed topics by type, in a manner that appeared to emulate an encyclopedic listing of data or, for example, a classification and filing system that might have been found in a brick-and-mortar library. Such a directory-based search engine had the advantages of seeming familiar to individual users and providing to the users lists of categories that, once selected, may display for the users lists of subcategories in order that the users may review information not only on the items of interest, but also on related items according to a broad categorizations.

Query-based search engines are the most common example of a search engine in use today. Query-based search engines afford a user an opportunity to enter one or more search terms as a web search query to satisfy an informational need for the user. As query-based search engines have evolved, they have become the typical search engine of choice by many users. The user enters search terms, most often as plain text terms, with certain characters or connectors added to define the scope of the user-requested search.

Hybrid search engines combine the query-based search schemes for inputting specific terms as details under a directory-based scheme in which information may initially be parsed into the broad categories of search. A broad topic may be addressed at a highest level in directory-based search engine hierarchies. Navigational queries may be directed at seeking a single website or a single web page for an individual transactional query directed at procuring a particular good or service, including for example purchasing a car or reviewing available real estate in a particular area, according to specific search criteria pertaining to the individually-desired good or service.

In order to gain some commercial advantage, search engine providers or administrators cooperate with individual providers of goods or services and individual advertisers to present an individual provider's website or an individual advertisement to the user in response to the user's query regarding a particular good or service. The interaction of the user with the individual provider's website then may result in a request by the particular good or service provider website for contact information for the user. In these circumstances, the user may be provided minimal information on the available goods or services from the provider in return for providing the user information to the goods or services provider as “leads,” which represent some level of contact information, that are typically passed to goods or services providers who will, in turn, use the contact information to have their sales representatives directly engage the users generally to the benefit of the goods or services providers.

The search engine providers or administrators attempt to filter the information responsive to users' inquiries in a manner that may appear to favor the users, but which actually leaves all of the power with the goods or services providers to transition the users' “window shopping” into directed advertising and/or an interactive sales pitch from a single good or service provider to which user lead information is provided. A particular user may be required to repeat the step of providing contact information individually to a number of separate goods or services providers. Sites that are “preferred” by the search engine providers or administrators may be prioritized over sites that may be more “preferred” by a particular user based on information previously gathered by the search engine providers or administrators. This is often done in order to enhance a level of revenues achievable by the search engine providers or administrators based on their preferable placing of particular responsive sites at a higher priority. Advertisers recognize that such premium placement may be to their advantage because large percentages of users look at only first or second webpages presented in response to their searches, particularly as each of a first number of webpages that a user may view in an attempt to shop for a particular good or service requests the user's contact information, while providing little in the way of specific product or service information to the user. This typical conventional scheme is often tedious, distracting and frustrating for the user. Interestingly, a comparable scheme exists in the world of social media in which one-on-one direct interaction between users may commence based on surprisingly limited information on either of the participating users, often according to the individual user's desire not to be encumbered, or concern, with having to provide too much information.

Regardless of schemes that search engine providers and/or administrators may employ to enhance a particular user's experience in navigating the search engine in instances where a user seeks to procure goods or to contract for services, it should be clear from the above discussion that the provision of particular responses to queries by an individual user, or group of users, are likely to the benefit of the search engine providers and/or administrators, often in cooperation with the providers of goods or services for their benefit as well, rather than directly to the benefit of the users. This is not say that certain benefits may not be provided to the users but rather is to indicate that such benefits to users are generally subservient to other benefits that may be of concern to the search engine providers and/or administrators, and the goods or services providers.

### SUMMARY OF EMBODIMENTS

It would be advantageous to exploit the interactive capabilities of the computing and communicating devices that users typically employ to initiate queries, automated information requests and/or social exchanges. Advantages may be realized in allowing individual users, or groups of users, to exchange increasingly-enhanced user contact information with goods or services providers or in social exchanges in a manner that may cause search engines that the users may employ to fairly quickly amass the enhanced contact information in a manner that better balances the benefits to the users with those to the other participants in the goods and/or services procurement schemes, or social interactions. Increasingly targeted responses to user inquiries may be realized through an automated scheme to gather additional user information to enhance the user contact information. The additional user information may be gathered from myriad publicly-available information sources and non-proprietary databases by referencing “known” information referenced to the basic contact information that the users provide.

Lead capture is a process by which primarily sales personnel amass contact information, and sometimes limited preference information, on potential customers for their goods or services. A particularly well-known form of lead capture is that generally undertaken by vehicle sales personnel that collect basic contact information up front prior to engaging in a review of available vehicles that may suit a particular potential customer's desires. This process has been minimally automated in the manner described above to the relative disadvantage of the customer.

Exemplary embodiments of the systems and methods according to this disclosure may further automate the process in a manner that shifts the equities in benefits more in the direction of the user by applying an automated scheme to generate enhanced user contact information and by more directly, and potentially limitedly, placing customers and goods and services providers in contact with each other, or social contacts sharing common interests in contact with one another when particular user preferences, trends, concerns, and/or characteristics are determined and applied.

Exemplary embodiments may provide a search engine that (1) allows a user to commence a directory-based search for particular goods or services, or for social contacts with particular characteristics on a first interactive interface page, (2) seeks basic user contact information to be entered on a second interactive interface page, (3) accesses available additional user information from multiple public and non-proprietary sources (including databases) to supplement, and thereby enhance, the basic contact information provided by the user, and (4) provides, on an immediate next page generated by the search engine, a list of a plurality of potential best resources for the particular goods or services, or a list of potentially-matching social contacts, that are sought by the user based on the enhanced user contact information.

Exemplary embodiments may share enhanced contact information for the user, which enhances basic user contact information that only needs to be entered once by the user as a part of the initial informational query, with the plurality of potential best resources for the particular goods or services that are sought by the user, or for particular social contacts with common interests to those of the user, based on the enhanced contact information developed for the user.

In exemplary embodiments, the immediate next page including the plurality of returned resources may represent a session-sensitive directory of available goods or services providers understanding that these may have a particular good based on a particular specificity to the user's search details, or may otherwise be volatile in the amount of information that they provide.

Exemplary embodiments may depart from the conventional lead-generating scheme in which certain pages provide a content directory for goods or service that a user may be seeking to provide, in response to a user's detailed “two-page” input, including user basic contact information, regarding what the user is seeking In the systems and methods according to this disclosure, a list of advertisers may be additionally provided to indicate those advertisers to which the user may desire that the user's enhanced contact information be provided. In embodiments then, the user's basic contact information, enhanced by the disclosed schemes to generate enhanced user contact information may be automatically forwarded to those selected advertisers while individual contact information for those advertisers may be provided directly via the search engine results, or may be provided, for example, in an email, or series of emails, from the search engine to the user regarding several individual goods or services providers.

In embodiments, page one of an automated user interface may represent a search page by which a user information request may be submitted, page two may facilitate entry of user basic contact information, and page three, returned in reply to pages one and two (and an additional automated user information search based on the entered user basic contact information), may provide links to individual goods or services providers to which the user's enhanced contact information may be collectively forwarded for use. The links to the goods providers may be to local or national, or worldwide resources. The links to the service providers maybe within a particular default range of an entered location for the user including, for example, the entered contact information address. Similarly, when the scheme is employed in a social networking scheme, the returned results may be appropriately geographically limited according to a user's desires.

Exemplary embodiments may provide that all of the highest ranked responsive results that the search engine may determine are particularly relevant to the particular goods or services that are sought by the user, and/or a particularly relevant social contact, would be listed on one or more of the third pages (page(s) three).

Exemplary embodiments may provide a web-based search service provider with a capacity to quickly populate particularly-focused vertical search services in an updatable manner.

Exemplary embodiments may obtain these objectives with users specifically selecting particular categories of searches to be undertaken for, for example, specific goods or services, or for social contacts, via an initial first automated user interface page. The landing page may be simply a hyper-directory.

Exemplary embodiments may be distinguished over conventional webpages and ask for a particular user's basic contact information prior to providing a user with, for example, price and processing information regarding a particular good or service by providing a particularly-focused return directory of goods and services in response to a particular user's request and criteria, and an automated search of “known” information and/or databases based on user-provided basic contact information and in exchange for generated user enhanced contact information. The various website hosts may get what they want in that they are provided with enhanced user contact information, and the consumer (user) may be provided with an array of choices, which may satisfy the user's request for goods, services or social contacts. In this manner, the user may get closer to what the user wants in that specific goods or services, or social contacts, are provided in a catalog format to a user from multiple goods or services providers, or other social contacts at the same time.

In exemplary embodiments, enhanced user contact information is provided in conjunction with the search engine. Typically, individual websites will collect contact information from users and then indicate that the users will be contacted by a sales or servicing representative. According to the disclosed exemplary embodiments, a user is provided with a targeted set of response results to its directory-based search thereby leaving some measure of control of the process with the user.

In embodiments, the user's information is collected and information that the user seeks may be immediately returned to the user, thereby benefiting the user in both ways.

These and other features, and advantages, of the disclosed systems and methods are described in, or apparent from, the following detailed description of various exemplary embodiments.

### BRIEF DESCRIPTION OF DRAWINGS

Various exemplary embodiments of the disclosed systems and methods for providing users and/or goods providers, services providers, or social contacts, with an interactive scheme for generating enhanced business contacts and/or enhanced social contacts in an automated manner while the user gains the benefit of being provided directed information responsive to user-initiated and directory-based queries and/or requests for information will be described, in detail, with reference to the following drawings, in which:

FIG. 1 illustrates a schematic diagram of an exemplary overview of a networked communication environment within which the user-interactive enhanced user information generating systems and methods according to this disclosure may operate;

FIG. 2 illustrates an exemplary embodiment of an overview of a series of linked pages in an automated user interface structure that may be sequentially displayed to support user-interactive enhanced user information generation according to this disclosure;

FIG. 3 illustrates detail of an exemplary embodiment of a first page of an automated user interface sequentially displayed according to this disclosure;

FIG. 4 illustrates detail of an exemplary embodiment of a second page of an automated user interface sequentially displayed according to this disclosure;

FIG. 5 illustrates detail of an exemplary embodiment of a third page of an automated user interface sequentially displayed according to this disclosure;

FIG. 6 illustrates a block diagram of an exemplary system that provides a mechanism for user interaction in generating enhanced user contact information according to this disclosure; and

FIG. 7 illustrates a flowchart of an exemplary method for implementing user interaction in generating enhanced user contact information according to this disclosure.

### DETAILED DESCRIPTION OF EMBODIMENTS

The systems and methods for providing users and/or goods providers, services providers or social contacts with an interactive scheme for generating enhanced business contacts and/or enhanced social contacts in an automated manner while the user gains the benefit of being provided directed information responsive to user-initiated and directory-based queries and information requests, as set forth in this disclosure, will generally refer to this specific utility for those systems and methods. Exemplary embodiments described and depicted in this disclosure should not be interpreted as being specifically limited to any particular communication network configuration, to any particular device or system by which a user may interact with a particular search engine, or multiple search engines, to any particular subsystem or scheme for automatically searching known databases for supplementing information, or to any particular search engine or use of the automated schemes for generating enhanced user contact information with the disclosed systems and methods. In fact, any information exchange capability that may facilitate a user's advanced interaction with a search engine that may provide additional benefit to the user by supplementing basic contact information input by the user in support of returning better or more focused results to user inquiries regarding goods providers, services providers or social contacts according to enhanced user profile information is contemplated to be included within the scope of this disclosure.

Specific reference to, for example, any particular communicating or computing device in wired or wireless communication with a search engine in a network environment by which a directory-based query or information request may be initiated, or by which information may be exchanged for enhancing user contact information to the benefit of goods providers, services providers, other advertisers, other social contacts and/or the customers/users should be understood as being exemplary only, and not limited, in any manner, to any particular device or class of devices. The disclosed systems and methods will be described as being particularly adaptable to being hosted on commercially-available hand-held wireless communicating devices such as smartphones, iPhones®, tablets, iPads®, PDAs, body-worn devices and the like, but should not be considered as being limited to only these classes and types of devices.

Individual features and advantages of the disclosed systems and methods will be set forth in the description that follows, and will be, in part, obvious from the description, or may be learned by practice of the features described in this disclosure. The features and advantages of the systems and methods according to this disclosure may be realized and obtained by means of the individual elements and combinations of those elements, as particularly pointed out in the appended claims. While specific implementations are discussed, it should be understood that this is done for illustration purposes only. A person skilled in the relevant art will recognize that other components and configurations may be used without departing from the spirit and scope of the subject matter of this disclosure.

Various aspects of the disclosed embodiments relate to a system and a method for providing users and/or goods providers, services providers, and social contacts with an interactive scheme for generating enhanced business contacts and/or enhanced social contacts in an automated manner while the user gains the benefit of being provided directed information responsive to user-initiated and directory-based queries and/or information requests. The disclosed schemes improve upon earlier lead capture methods by allowing users to take greater control of the process through user-centric automation. This automation provides an opportunity for a user to seek specific goods or services, or social contacts, to enter basic user contact information one time in the context of the user-interactive search for the goods or services, or social contacts, to have that basic user contact information supplemented in a an automated scheme to generate enhanced user contact information, and to be provided a plurality of responses to the user's search indicating a plurality of goods or services providers, or a plurality of social contacts, that have been forwarded the user's enhanced contact information supplemented with additional information accessed by the automated scheme and collected/collated to provide enhanced user contact information.

As an example of a scenario in which the systems and methods according to this disclosure may be implemented, consider a user doing research on a particular make and model of a new or used car to purchase in an effort to discern local, or perhaps even national, availability of a particular vehicle, or group of vehicles, that meets the user's criteria. The user may initiate a directory-based search for a particular vehicle according to a number of search criteria. The results provided to the user by a selected search engine with which the user is conducting his or her search may include a large number of individual listings and a number of Web pages, including a particular individual dealer, or a dealer database, Web page in a first or top spot in the search results. The user may select the dealer Web page based on its placement in the search results and the understanding that the dealer has one or more vehicles that meet the user's criteria only to be confronted with a request for contact information from the user and not any particular vehicle listing. The dealer is provided with the contact information and sales personnel from the dealer and the user may rarely be provided with any confirmation that the particular vehicle according to the user's search criteria is actually available. The result is that the user waits to be contacted and the search stalls at a point where the user may not even have achieved his or her desired result. In other words, the user, looking for a particular product, achieves only delivery of the user's basic contact information to a particular “potential” product provider.

The systems and methods according to this disclosure, in embodiments, may provide a more satisfying user experience in affording the user a return of a better, and potentially more precisely focused, scope of information in response to the user's directory-based search while developing a database of enhanced user contact information in an automated manner to the benefit of all of the participants in the content delivery process including the user, the search engine provider or administrator, goods or services providers, other social contacts and/or related advertisers. According to the disclosed schemes, when it is recognized by the search engine that the user is conducting a search for a particular good or service, or for a particular set of social contacts meeting certain criteria, the search engine, prior to initiating the search according to the user's entered parameters, may request that the user enter the user's basic contact information once in the context of the immediate search. The search engine may then, in a manner generally transparent to the user, undertake a data search of multiple data sources and/or multiple databases for available information regarding the user based on the entered basic contact information for the user. The search engine may then associate the user's basic contact information and returned additional information regarding the user in association with the details of the user's query as enhanced contact information for the user. The developed enhanced contact information for the user may then be forwarded to a series of goods or services providers, or a plurality of social contacts, that meet the user's initial query criteria and return to the user lists of goods or services providers, or lists of social contacts, that meet the user's initial query criteria according to a very disciplined and particular scheme.

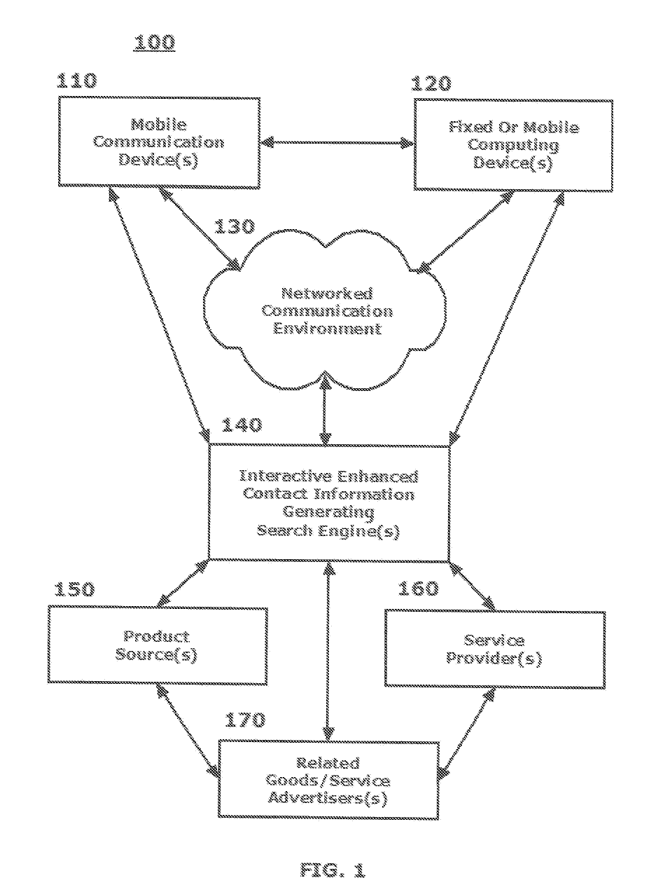

FIG. 1 illustrates a schematic diagram of an exemplary overview 100 of a networked communication environment 130 within which the systems and methods according to this disclosure may operate. As shown in FIG. 1, any one or more of a mobile communication device 110 and a fixed or mobile computing device 120 (or pluralities of each of these classes of devices) may be provided to allow individual users or groups of users to gain access to one or more interactive enhanced contact information generating search engines 140, either directly or via at least a networked communication environment 130. Various ones of a mobile communication device 110 and a fixed or mobile computing device 120 may communicate directly with one another to sync the information between the various ones of the devices. Ultimately, the interactive enhanced contact information generating search engines 140, which are administered by one or more search engine providers, may be usable to allow the individual users to gain access to the vast amount of information that is available via the Internet, and particularly in the context of this disclosure, one or more product sources 150 and/or one or more service providers 160, including social contact providers.

Using any one or more of the mobile communication device 110 and the fixed or mobile computing device 120, users may conduct directory-based query and/or information request to find one or more goods or services, or social contacts, that satisfy the users' particular request criteria. The interactive enhanced contact information generating search engines 140 will return and display to the user a basic contact information page for the user to populate with the user's basic contact information. As a result of submission of basic contact information by the user, the interactive enhanced contact information generating search engine 140 may reference the user's basic contact information and conduct a search of available data sources (including various databases) to supplement that basic contact information with publicly available information associated with the user's basic contact information to develop enhanced contact information regarding the user. The interactive enhanced contact information generating search engine 140 may then return search results regarding, for example, links, webpages, domain names, URLs or the like provided as product sources 150, or service providers 160, or social contacts, that the interactive enhanced contact information generating search engine 140 determines to be responsive to the user's directory-based query and/or information request. The interactive enhanced contact information generating search engine 140 may forward the user enhanced contact information to the selected product sources 150 and service providers 160, including social contact exchanges.

As indicated above, a database may be populated with enhanced user contact information based on the basic contact information for the users and the product sources 150 and the service providers 160. The database may facilitate broadening the base of information that the interactive enhanced contact information generating search engine 140 may employ to enhance the user experience by streamlining the user process and providing more targeted results to the user. In this manner, the disclosed schemes are intended to address one or more perceived shortfalls in the conventional automated basic lead capture schemes.

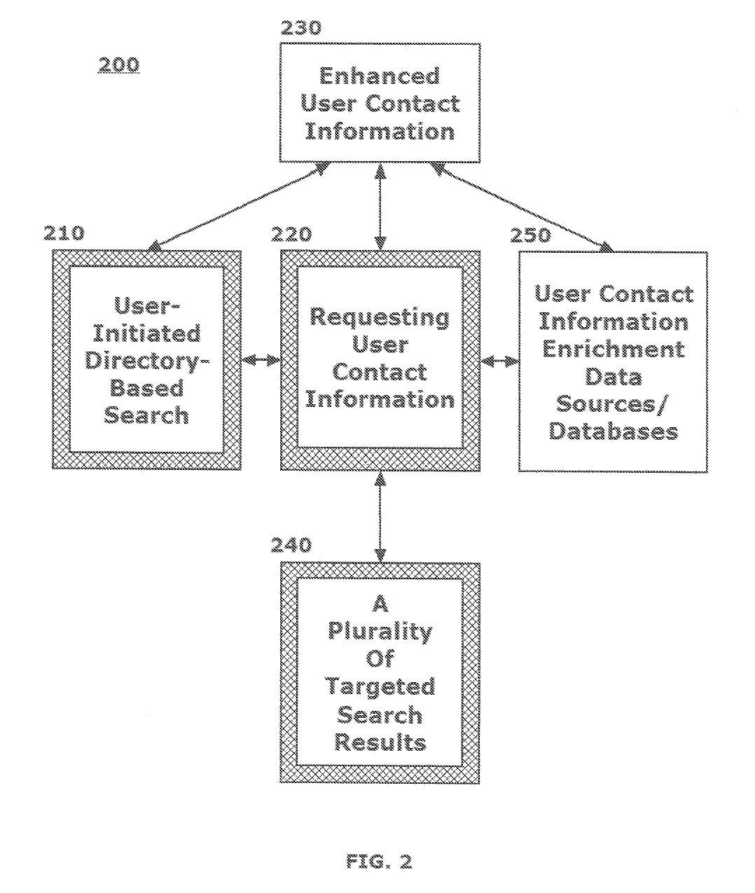

FIG. 2 illustrates an exemplary embodiment of an overview 200 of a series of linked webpages in an automated user interface structure that may be sequentially displayed to support user-interactive enhanced contact information generation according to this disclosure. As shown in FIG. 2, a first automated user interface page 210 may be displayed for a user to initiate a directory-based query, search or information request for a particular good or service. A second automated user interface page 220 may be displayed for requesting, and accepting input of, user basic contact information. Together, the information provided to the search engine by the user using the first and second automated user interface pages 210,220 may be collected and associated by the search engine as user contact information. The search engine may then reference the user basic contact information and conduct a search of available public user contact enrichment data sources/databases 250 to supplement that basic contact information with publicly available information associated with the user basic contact information to develop enhanced contact information regarding the user to be forwarded for use to a plurality of goods or services providers, or a plurality of other social contacts. The plurality of goods or services providers, or other social contacts, may be those that are determined by the search engine to potentially have goods or services that may be responsive to the user's search, or may be social contacts that potentially have characteristics that may be responsive to the user's search. Meanwhile, the search engine may return for display to the user a plurality of targeted search results 240 that may be responsive to the user's search. Some indication may be provided in association with each of the returned results as to whether the user's contact information may have been provided to one or more of the Web page or link providers, or to one or more other social contacts, as enhanced contact information for the user. Regardless of the content of the displays, the disclosed and depicted scheme may aid in quickly populating an enhanced contact information database for use by the search engine provider and/or administrator in better responding to user needs.

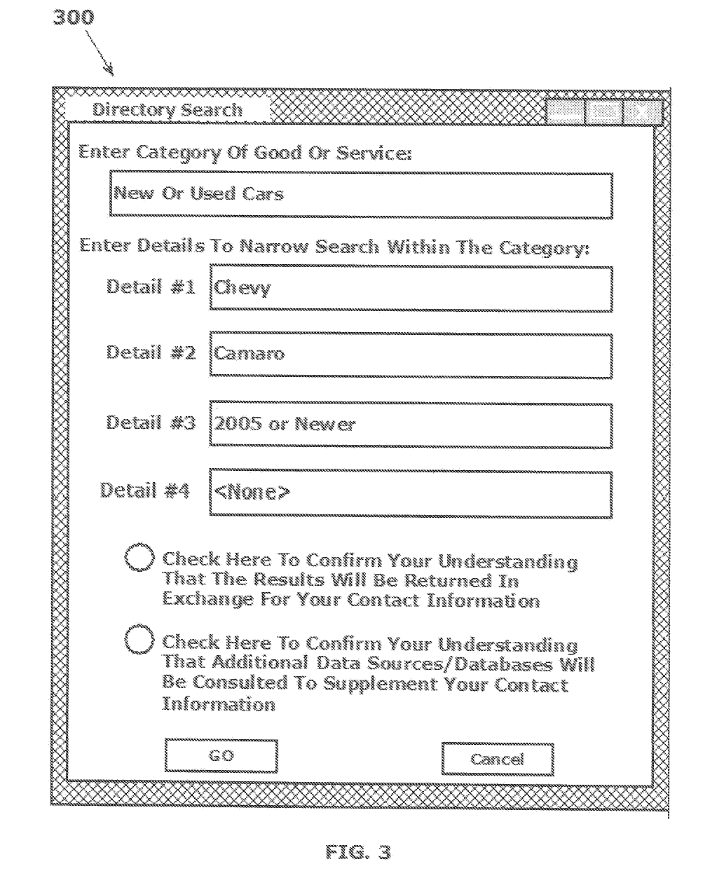

FIG. 3 illustrates detail of an exemplary embodiment 300 of a first page of an automated user interface to be sequentially displayed to a user on the one of the mobile communication device or the fixed or mobile computing device by which the user conducts an automated information search for goods or services providers. The exemplary embodiment of the first page of the automated user interface 300 shown in FIG. 3 is intended to be representative of a typical user interface that may be presented to the user on a display of the one of the mobile communication device or the fixed or mobile computing device to implement portions of the enhanced user contact information generation scheme via a search engine, as described above.

Using the first page of the automated user interface 300, the user may input information required to commence the directory search for a particular good or service, or a responsive social contact. In the example shown in FIG. 3, a non-limiting example that will be continued throughout the following discussion, the user may seek information on the purchase of a particular make and model of a new or used car according to particular details that the user enters into the exemplary first page of the automated user interface 300.

Because the chosen search engine is an interactive enhanced contact information generating search engine, some manner may be provided by which to allow the user to verify his or her willingness to provide basic contact information via the search engine. This verification can take many forms. Some manner may be provided by which to allow the user also to verify his or her willingness to have the search engine search other databases for information on the user related to the user's input basic contact information. A result of an unwillingness on the part of the user to provide basic contact information or to accede to the extended search in the context of responding to the user's information request may result in the user, for example, being informed that search results may be modified, incomplete or not returned at all. A user may then have to determine whether the participation in the particularly-directed search warrants the exchange of basic contact information with the search engine, and the search engine autonomously searching other databases for information related to the user's basic contact information. A user may then have to permit the opportunity for the search engine to reference available databases to associate additional available information from those databases with the user basic contact information to produce enhanced contact information for further use by the search engine.

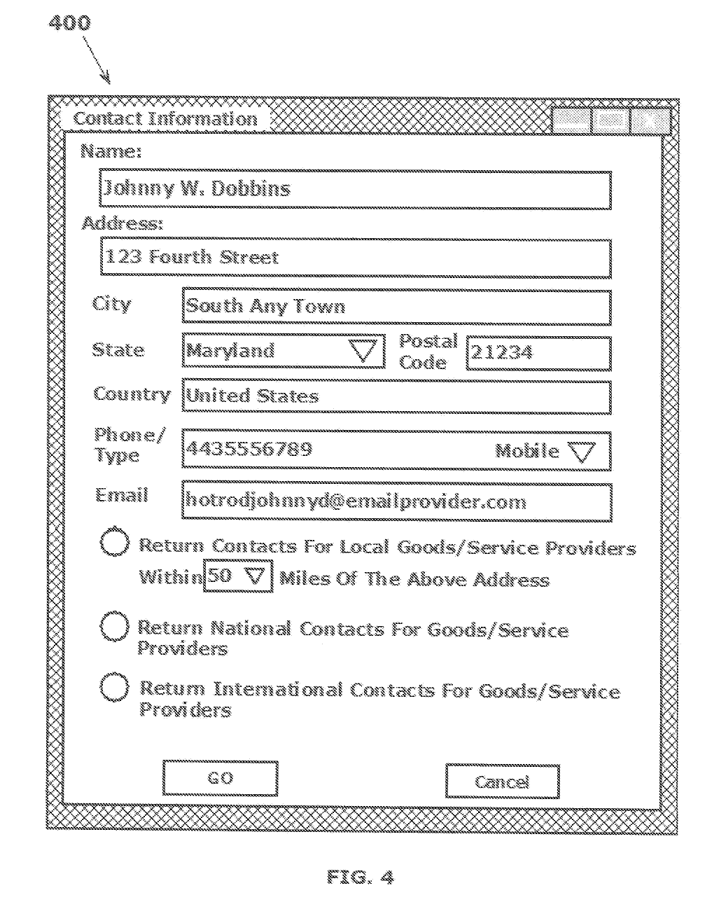

FIG. 4 illustrates detail of an exemplary embodiment 400 of a second page of an automated user interface to be sequentially displayed to a user on the one of the mobile communication device or the fixed or mobile computing device by which the user conducts an automated information search for goods or services providers. The exemplary embodiment of the second page of the automated user interface 400 shown in FIG. 4 is intended to be representative of a typical user interface that may be presented to the user on a display of the one of the mobile communication device or the fixed or mobile computing device to implement portions of the enhanced automated lead capture scheme via a search engine, as described above.

Using the second page of the automated user interface 400, the user may input basic contact information requested by the search engine to continue the directory search for the particular good or service. The basic contact information captured from the exemplary second page 400 of the automated user interface may be used by the search engine to query available databases for additional data that may be associated with the basic contact information to provide enhanced contact information regarding the user. The enhanced contact information may be compiled and forwarded to the one or more of the goods or services providers that the search engine determines may have goods or services that the search engine determines to be responsive to the user's search criteria. In the example shown in FIG. 4, the use of the non-limiting example shown in FIG. 3 continues in which the user seeks information on the purchase of the particular make and model of the new or used car.

In addition to providing basic contact information, the user may be prompted to indicate, for example, whether the user wants to regionally limit the search in some manner that may be appropriate to the good or service that the user seeks. It is reasonable, for example, that the user may be willing to have a broad national or even international search undertaken for a particular good that is easily shipped, to limit a search for particular goods like real estate or vehicles to a particular region, and to further limit a search for services to those that may be available from particularly local service providers.

The search engine may then forward the generated enhanced contact information to a plurality of goods or services providers that are determined to have goods or services that satisfy the user's search criteria, while returning to the user Web pages, links, domain names, URLs and the like for the plurality of goods or services providers that satisfy the user's search criteria.

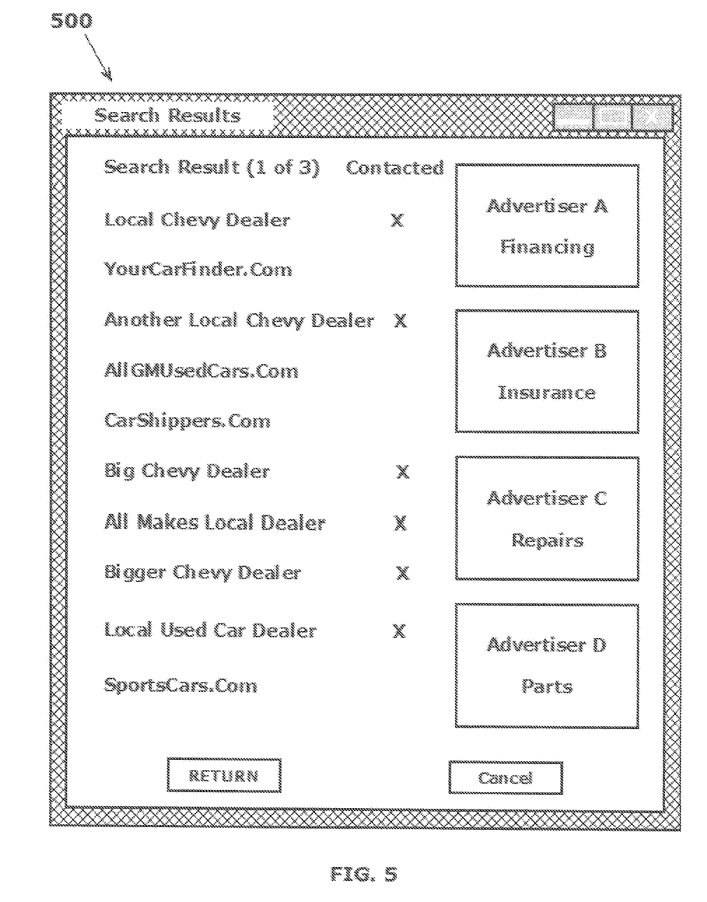

FIG. 5 illustrates detail of an exemplary embodiment 500 of a third page of an automated user interface to be sequentially displayed to a user on the one of the mobile communication device or the fixed or mobile computing device by which the user conducts an automated search for goods or services providers. The exemplary embodiment of the third page of the automated user interface 500 shown in FIG. 5 is intended to be representative of a typical user interface that may be presented to the user on a display of the one of the mobile communication device or the fixed or mobile computing device to implement portions of the enhanced contact information generating scheme via a search engine, as described above.

Using the third page of the automated user interface 500, the user may receive the list Web pages, links, domain names, URLs or the like for the plurality of goods or services providers that the search engine determines satisfy the user's search criteria, and to the which entities the enhanced contact information may be forwarded. An indication may be provided that the displayed page is one of multiple pages of search results. There also may be provided an indication that less than all of the displayed results have been provided with the enhanced contact information.

Additionally, continuing the non-limiting example regarding a user's desire to purchase a particular make and model of a new or used car according to the particular details, the search engine may select for display certain related advertising information that is not precisely responsive to the user's requested search, but rather is determined by the search engine to be additional information that may be useful to the user in support of the results that are returned directed specifically to the user's search criteria, and in consideration of the additional information regarding the user that is included in the enhanced lead contact information for the user.

It should be appreciated that the above description provides an overview of several options that may be made available to a user. Those of skill in the art will, however, readily recognize that other options for generating enhanced contact information within the disclosed scheme may be provided.

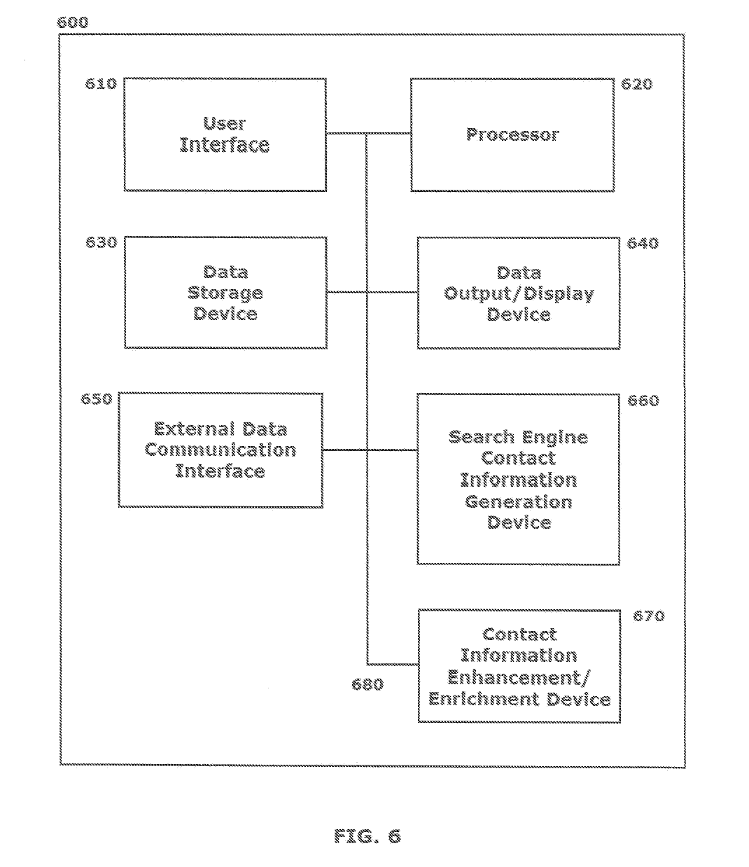

FIG. 6 illustrates a block diagram of an exemplary system 600 that provides a mechanism for user interaction in generating enhanced user contact information via an interactive search engine according to this disclosure. The exemplary system 600 shown in FIG. 6 may be embodied in, for example, one or more of a mobile communication device or a fixed or mobile computing device. See generally FIG. 1.

The exemplary system 600 may include a user interface 610 by which the user may communicate with the exemplary system 600. The user interface 610 may be configured as one or more conventional mechanisms that permit a user to input information to the exemplary system 600. The user interface 610 may include, for example, an integral or attached keyboard and/or mouse by which a user may enter data into the exemplary system 600. The user interface 610 may alternatively include (1) a touchscreen with “soft” buttons, or for use with a compatible stylus; (2) a microphone by which a user may provide oral commands to the exemplary system 600 to be “translated” by a voice recognition program or otherwise; or (3) other like devices for user operation of, and data exchange with, the exemplary system 600. The user interface 610 may be integrated into a graphical user interface (GUI) associated with one or more of the mobile communication device or the fixed or mobile computing device operated by the user and of which the exemplary system 600 may be a part or function.

The exemplary system 600 may also include one or more local processors 620 for individually operating the exemplary system 600 and carrying out processing and control functions associated with the disclosed schemes. Processor(s) 620 may include at least one conventional processor or microprocessor that interprets and executes instructions to execute communications and facilitate the determinations and display components for user interaction with an interactive enhanced contact information search and generating scheme according to the methods of this disclosure.

The exemplary system 600 may include one or more data storage devices 630. Such data storage devices 630 may be used to store data or operating programs to be used by the exemplary system 600, and specifically the processor 620. Data storage device(s) 630 may include a random access memory (RAM) or another type of dynamic storage device that stores information and instructions for execution by processor(s) 620. Data storage device(s) 630 may also include a read-only memory (ROM), which may include a conventional ROM device or another type of static storage device that stores static information and instructions for processor(s) 620. Further, the data storage devices 630 may be integral to the exemplary system 600, or may be provided external to, and in wired or wireless communication with, the exemplary system 600.

At least one of the data storage devices 630 may be configured to store a database that lists webpages, links, domain names, URLs or the like that are often visited by the user that may be associated with a particular user's basic contact information for generating enhanced contact information for the user according to the disclosed schemes. It is anticipated that the search engine may generally store the enhanced contact information for the user in an accessible manner. The enhanced contact information for a particular user may be stored on, or associated with, the user's particular interactive device as a backup or in a modification of the disclosed general implementation. The database may include the basic contact information that the user input, and the returned enhancing information that the search engine found, to be associated with returned Web pages, links domain names, URLs or the like.

The exemplary system 600 may include at least one data output/display device 640 which may be configured as one or more conventional mechanisms that output information to the user or that otherwise provide a mechanism by which the user may interact for information exchange with the exemplary system 600 according to known methods.

The exemplary system 600 may include one or more external data communication interfaces 650 by which the exemplary system 600 may communicate with components external to the exemplary system 600 including other communication devices with which the exemplary system 600 may be in wired or wireless communication. It is via these external data communication interfaces 650, for example, that the exemplary system 600 may communicate with the one or more search engines for interactive enhanced contact information generation. External data communication interface(s) 650 may include any mechanism that facilitates direct communication, or communication via a network environment, for interaction with the search engines.

The exemplary system 600 may include a search engine contact information generation device 660 that is usable to specifically implement the enhanced contact information generation methodologies outlined above. Components of the search engine contact information generation device 660 may include the mechanisms for generating the multiple pages of the automated user interface and for accepting user input via the multiple pages of the automated user interface as discussed above with reference to the depictions in FIGS. 2-5. Additionally, components of the search engine contact information generation device 660 may include a specifically segregated storage device in which a database such as that discussed above may be housed.

The exemplary system 600 may include a contact information enhancement/ enrichment device 670 by which the exemplary system 600 may specifically find and interrogate various databases based on the basic contact information provided by the user to return data that may be combined with the basic contact information to produce enhanced contact information for the user. The enhanced contact information may then be shared with various goods and services providers in accordance with the disclosed schemes.

All of the various components of the exemplary system 600, as depicted in FIG. 6, may be connected by one or more data/control busses 680. These data/control busses 680 may provide wired or wireless communication between the various components of the exemplary system 600, whether all of those components are housed integrally in, or are otherwise external and connected to, any communicating or computing device with which the exemplary system 600 is associated.

It should be appreciated that, although depicted in FIG. 6 as an integral unit, the various disclosed elements of the exemplary system 600 may be arranged in any combination of sub-systems as individual components or combinations of components, integral to a single unit, or external to, and in wired or wireless communication with the single unit of the exemplary system 600. In other words, no specific configuration as an integral unit or as a support unit in communication with other units or devices is to be implied by the depiction in FIG. 6.

It should also be appreciated that the system storage and processing functions described above, given the proper inputs, may be carried out in system hardware circuits, software modules or instructions or firmware, or in varying combinations of these.

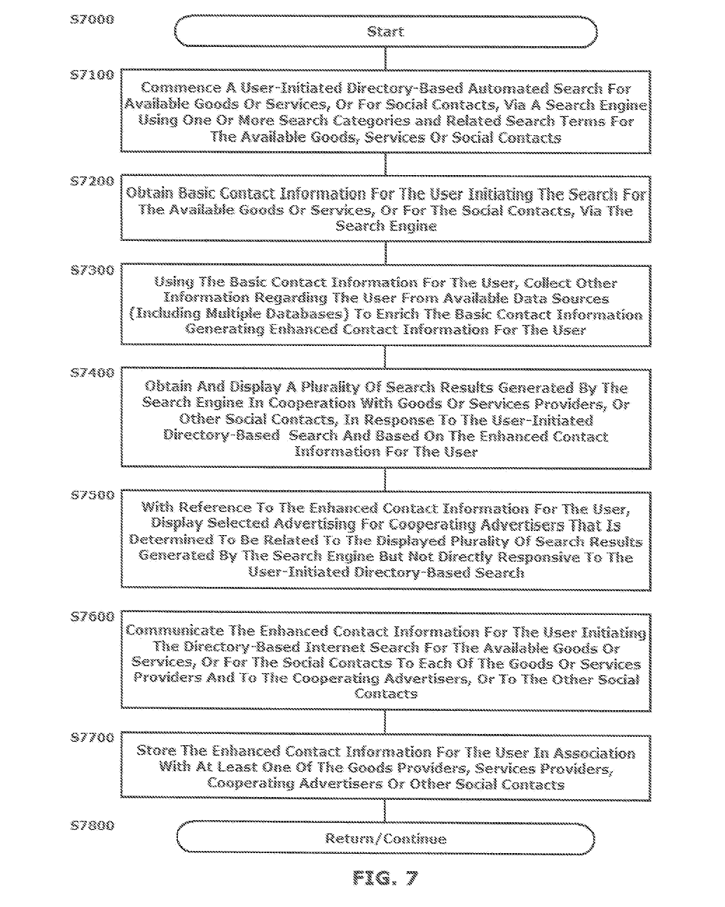

The exemplary embodiments may include a method for implementing user interaction in generating enhanced user contact information via a search engine according to this disclosure. FIG. 7 illustrates a flowchart of such an exemplary method. As shown in FIG. 7, operation of the method commences at Step S7000 and proceeds to Step S7100.

In Step S7100, a user may initiate a directory-based automated search for available goods or services, or social contacts, via a search engine using one or more search categories and related search terms for the desired available goods, services or social contacts. Operation of the method proceeds to Step S7200.

In Step S7200, the search engine may obtain basic contact information for the user initiating the directory-based automated search prior to completing the search and returning the search results to the user. Operation of the method proceeds to S7300.

In Step S7300, the search engine may use the obtained basic contact information for the user to search for, and collect, other information regarding the user from available public and non-proprietary data sources (including databases) to supplement the basic contact information and enrich the basic contact information for the user to generate enhanced contact information. Operation of the method proceeds to Step S7400.

In Step 7400, a plurality of search results generated by the search engine in cooperation with the goods or services providers, or other social contacts, and in response to the user-initiated directory-based search may be returned by the search engine and displayed on a display screen of the communicating or computing device by which the user initiated the directory-based search. Operation of the method proceeds to Step 7500.

In Step 7500, the search engine may select for display advertising for cooperating advertisers, the selected advertising being determined, for example, to be related to the displayed plurality of search results generated by the search engine and the enhanced contact information generated by the search engine. The displayed selected advertising may not be directly responsive to the user's entered search criteria for the directory-based search. Operation of the method proceeds to Step S7600.

In Step 7600, the search engine may communicate the enhanced contact information for the user initiating the directory-based search seeking available goods or services, or the social contacts, to determined goods or services providers, cooperating advertisers or to the other social contacts as enhanced contact information. The search engine may signify in the display of the search results some indication regarding to which of the displayed providers and/or advertisers and/or other social contacts the user's enhanced contact information for the user is provided. Operation of the method proceeds to Step S7700.

In Step 7700, the enhanced user contact information may be stored in association with at least one of the goods or services providers and/or the cooperating advertisers and/or other social contacts for one of the user, the goods or services providers or the cooperating advertisers or the social contacts. Operation of the method proceeds to Step S7800, where operation of the method is made to repeat or continue.

The disclosed embodiments may include a non-transitory computer-readable medium storing instructions which, when executed by a processor, may cause the processor to execute the steps of the method described above.

Overall benefits of the disclosed embodiments may include simple and practical mechanisms by which a user may obtain beneficial and more complete results to an automated search, query or information request for available goods and services in response to entering basic contact information for generating enhanced contact information via the search engine one time in order that the user may take some additional control of the search engine results.

The above-described exemplary systems and methods reference certain conventional components to provide a brief, general description of a suitable communication and processing environment in which the subject matter of this disclosure may be implemented for familiarity and ease of understanding. Although not required, embodiments of the disclosure may be provided, at least in part, in a form of hardware circuits, firmware or software computer-executable instructions to carry out the specific functions described, such as program modules, being executed by a processor. Generally, program modules include routine programs, objects, components, data structures, and the like that perform particular tasks or implement particular data types.

Those skilled in the art will appreciate that other embodiments of the disclosed schemes and techniques may be practiced in computing and communication network environments with many types of communication equipment and supporting computer system configurations, including personal computers, hand-held devices, body-worn devices, multi-processor systems, microprocessor-based or programmable consumer electronics, and the like.

Embodiments may also be practiced in distributed communication and computing environments where tasks are performed by local and remote processing devices that are linked to each other by hardwired links, wireless links, or a combination of both through a communication network. In a distributed communication and/or computing environment, program modules may be located in both local and remote memory storage devices.

Embodiments within the scope of this disclosure may also include non-transitory computer-readable media having stored computer-executable instructions or data structures that may be accessed, read and executed by the user's local wireless communication device using a compatible wired or wireless data reader. Such computer-readable media may be any available media that may be accessed by a processor, general purpose or special purpose computer in, or in communication with, the user's local wireless communication device. By way of example, and not limitation, such computer-readable media may comprise RAM, ROM, EEPROM, CD-ROM, flash drives, data memory cards or other analog or digital data storage device that may be used to carry or store desired program elements or steps in the form of accessible computer-executable instructions or data structures. When information is transferred or provided over a network or another communications connection, whether wired, wireless, or in some combination of the two, the receiving processor properly views the connection as a computer-readable medium. Thus, any such connection is properly termed a computer-readable medium. Combinations of the above should also be included within the scope of the computer-readable media for the purposes of this disclosure.

Computer-executable instructions include, for example, non-transitory instructions and data that may be executed and accessed respectively to cause any of the described communication devices, or processors associated with such devices, to perform certain of the above-specified functions, individually, or in combination. Computer-executable instructions also include program modules that are remotely stored for access by the described communication and/or computing devices to be executed by the processors in the described communication and/or computing devices when the devices are caused to communicate in a network environment. The exemplary depicted sequence of executable instructions or associated data structures represents one example of a corresponding sequence of acts for implementing the functions described in the steps. Not all steps need to be executed in order to be considered as completing the disclosed method. Also, no particular order to the method steps is to be implied by the depiction in FIG. 7, and the accompanying description, except where completion of a particular method step is a necessary precondition to completion of a subsequent method step.

Although the above description may contain specific details, they should not be construed as limiting the claims in any way. Other configurations of the described embodiments of the disclosed systems and methods are part of the scope of this disclosure. For example, the principles of the disclosure may be applied to each individual user where each user may individually deploy such a system or method to initiate directory-based automated searches. This enables each user to use the benefits of the disclosure even if any one of the large number of possible applications do not need a specific aspect of the functionality described and depicted in this disclosure. In other words, there may be multiple instances of the described components each processing information content in various possible ways. It does not necessarily need to be one system used by all end users. Accordingly, the appended claims and their legal equivalents should only define the disclosure, rather than any specific examples given.

We claim:

1. A method for capturing user contact information, comprising:
receiving, with a processor, an automated information request from a user via a device in communication with the processor;
providing, with the processor, an automated user interface on a display portion of the device, the automated user interface providing a mechanism for the processor to receive basic user contact information to associate with the automated information request via the device;
receiving, with the processor, the basic user contact information associated with the automated information request input by the user;
conducting a first automated search of available data sources for information on the user related to the basic contact information for the user to supplement the basic contact information as enhanced contact information;
conducting a second automated search responsive to the user's automated information request based on a combination of information including search terms for the initiated automated information request and the enhanced contact information;
receiving, with the processor, results of the second automated search, the received results being responsive to the combination of information; and
displaying the received results on the display portion of the device.

2. The method of claim 1, the search being initiated by the user in communication with the search engine via the device, the user inputting the search terms through a user-manipulated input portion of the device by which the user populates a first page of the automated user interface.

3. The method of claim 2, the first page of the automated interface presenting the user with an option regarding the inclusion of the basic user contact information.

4. The method of claim 3, the basic user contact information being input on an immediately displayed second page of the automated user interface in response to user inputs on the first page of the automated user interface.

5. The method of claim 1, the second automated search seeking information on at least one of a good that the user seeks to purchase, a service for which the user seeks to contract or a social contact with which the user desires to interact based on specified criteria, the received results of the second automated search specifying at least one of a plurality of individual web pages, a plurality of individual links, a plurality of domain names, a plurality of social contacts or a plurality of individual uniform resource locators (URLs) pertaining to a plurality of goods or services providers, or a plurality of social contacts, responsive to the search.

6. The method of claim 5, the first automated search of available data sources including searches of a plurality of databases for information on the user that may be associated with the basic contact information.

7. The method of claim 5, the enhanced contact information being forwarded to at least some of the plurality of goods or services providers or the plurality of social contacts responsive to the search.

8. The method of claim 7, the search engine returning an indication of which of the at least some of the plurality of goods or services providers or the plurality of social contacts have the enhanced contact information forwarded to them, and the processor formatting a third page of the automated user interface to display the received results to indicate which of the some of the plurality of goods or services providers or the social contacts have the enhanced contact information forwarded to them.

9. The method of claim 8, the third page of the automated user interface including advertising information that the search engine determines is related to the received results and based on the enhanced contact information.

10. The method of claim 1, the enhanced contact information being stored in a storage device associated with the processor.

11. The method of claim 1, the processor being associated with the search engine.

12. The method of claim 1, the processor being in the device.

13. A system for capturing contact information, comprising:
a device that is usable by a user to initiate an automated information request, the device including,
a display portion that displays an automated user interface with which a user interacts to initiate the automated information request and to input basic user contact information,
a user-manipulated input portion by which the user populates the automated user interface, and
an external communication interface via which the device communicates with a search engine for conducting a search for results that satisfy the user's automated information request; and
a processor that is programmed to
format and direct a display of the automated user interface on the display portion of the device, the automated user interface providing a mechanism for the processor to receive the basic user contact information associated with the automated information request input by the user via the device,
receive the basic user contact information,
initiate a first automated search of available data sources for information on the user related to the basic contact information for the user to supplement the basic contact information as enhanced contact information;
initiate a second automated search responsive to the user's automated information request based on a combination of information including search terms for the automated information request and the enhanced contact information via an automated search engine,
receive results of the second automated search from the automated search engine, the received results being responsive to the combined information, and
direct display of the received results on the display portion of the device.

14. The system of claim 13, the search being initiated by the user in communication with the search engine via the device, the user inputting the search terms through the user-manipulated input portion of the device by which the user populates a first page of the automated user interface.

15. The system of claim 14, the first page of the automated interface presenting the user with an option regarding the inclusion of the basic user contact information.

16. The system of claim 15, the basic user contact information being input on an immediately displayed second page of the automated user interface in response to user inputs on the first page of the automated user interface.

17. The system of claim 13, the initiated second automated search seeking information on at least one of a good that the user seeks to purchase, a service for which the user seeks to contract or a social contact with which the user desires to interact based on specified criteria, the received results of the second automated search specifying at least one of a plurality of individual web pages, a plurality of individual links, a plurality of domain names, a plurality of social contacts or a plurality of individual uniform resource locators (URLs) pertaining to a plurality of goods or services providers or plurality of social contacts responsive to the search.

18. The system of claim 17, the initiated first automated search of available data sources including searches of a plurality of databases for information on the user that may be associated with the basic contact information.

19. The system of claim 17, the processor being further programmed to forward the enhanced contact information to at least some of the plurality of goods or services providers or the plurality of social contacts responsive to the search.

20. The system of claim 19, the search engine returning an indication of which of the at least some of the plurality of goods or services providers or the plurality of social contacts have the enhanced lead contact information forwarded to them, the processor being further programmed to format a third page of the automated user interface to display the received results to indicate which of the some of the plurality of goods or services providers or the social contacts have the enhanced contact information forwarded to them.

21. The system of claim 20, the third page of the automated user interface including advertising information that the search engine determines is related to the received results and based on the enhanced contact information.

22. The system of claim 13, the enhanced contact information being stored in a storage device associated with the processor.

23. The system of claim 13, the processor being associated with the search engine.

24. The system of claim 13, the processor being in the device.

25. A non-transitory computer-readable medium storing instructions which, when executed by a processor, cause the processor to execute a method for capturing user contact information, the method comprising:
receiving an automated information request from a user via a device;
providing an automated user interface on a display portion of the device, the automated user interface providing a mechanism for the processor to be provided with basic user contact information to associate with the automated information request via the device;
receiving the basic user contact information associated with the automated information request input by the user;
conducting a first automated search of available data sources, including a plurality of databases for information on the user related to the basic contact information for the user to supplement the basic contact information as enhanced contact information;
conducting a second automated search responsive to the user's automated information request based on a combination of information including search terms for the initiated automated information request and the enhanced contact information;
receiving results of the second automated search, the received results being responsive to the combination of information; and
displaying the received results on the display portion of the device.
